(19) United States
(12) Patent Application Publication
(10) Pub. No.: US 2026/0295631 A1
(43) Pub. Date: Oct. 1, 2026

(54) METHOD AND SYSTEM FOR PRE-TREATING A SURFACE OF NON-INSTALLED MECHANICAL CONNECTING ELEMENTS, AND AIRCRAFT OR SPACECRAFT

(71) Applicant: Airbus Operations GmbH, Hamburg (DE)

(72) Inventors: Ralf Schomaker, Bremen (DE); Jörn Skirke, Schneverdingen (DE); Stefan Kreling, Bremen (DE)

(73) Assignee: Airbus Operations GmbH, Hamburg (DE)

(21) Appl. No.: 19/577,533

(22) Filed: Mar. 25, 2026

(30) Foreign Application Priority Data
Mar. 27, 2025 (DE) 102025001079.6

(51) Int. Cl. B05D 3/12; B05D 3/06; B23K 26/36; B24C 1/00; B64F 5/10

(52) U.S. Cl. CPC B05D 3/12; B23K 26/36; B24C 1/00; B64F 5/10; B05D 3/067

(57) ABSTRACT

A method for pretreatment of a surface of non-installed mechanical connectors for production of an outer structure of aircraft or spacecraft includes providing a non-installed mechanical connector of which the surface is made of a metal material, mechanically and/or physically removing the surface of the mechanical connector, so that an adhesion-promoting layer is produced on the surface, and securing the mechanical connector to a structure after the surface of the mechanical connector has been mechanically and/or physically removed. A system and an aircraft or spacecraft are also disclosed.

### TECHNICAL FIELD

The disclosure herein relates to a method for pretreatment of a surface of non-installed mechanical connecting elements, or connectors, in particular for the production of an outer structure of aircraft or spacecraft. The disclosure herein further relates to a system for pretreatment of a surface of non-installed mechanical connectors, in particular for the production of an outer structure of aircraft or spacecraft, and to an aircraft or spacecraft.

### BACKGROUND

The wettability of metals and metal oxides with liquid, semi-solid and solid substances and the adhesion of the substances to the metals and metal oxides strongly depends on the surface finish. This is extremely important in the case of treatment with or application and adhesion of materials such as glue, paint, solder, sealant or organic woven fabrics. Degreasing and other kinds of further cleaning and pickling increase the wettability and adhesion to a certain degree. In addition to a morphology, the chemistry of the surface and the correct dimension of a surface roughness also influence the adhesion of the substances used for the coating. A structuring of the surface, preferably on several size scales, that affords an enlargement of the wetted surface has a positive effect, in the same way as a selective chemical modification and the creation of thermodynamically stable oxide layers, on the establishment of a durable adhesive bond.

A conventional method for producing an outer structure for an aircraft comprises a process of sanding the fully mounted outer structure, in order to prepare the surface of the outer structure including the rivets secured thereto for the paint-finishing. Owing to manufacturing tolerances—both in the production of the rivets and in the mounting—generally the rivets are recessed in relation to or project beyond the surface of the outer structure. In particular the recessed state gives rise to difficulties in sanding the rivet head so that the paint adheres properly.

Methods for this are known in the prior art. For example, EP 2 729 604 A2 describes a method for producing an adhesion-promoting layer on a surface of a titanium material, comprising: introducing the surface into an aqueous alkaline solution comprising sodium hydroxide with a concentration in a range of 100-300 g/l, sodium tartrate with a concentration in a range of 20-200 g/l, methylglycinediacetic acid Na3 with a concentration in a range of 5 g/l- 60 g/l, pentasodium triphosphate with a concentration in a range of 2 g/l- 20 g/l; and applying a voltage between the solution and the titanium material for a predetermined duration to produce the layer by anodic oxidation of the surface. This known production method is therefore a bath process.

### SUMMARY

The object of the disclosure herein is to provide improved solutions for producing a weather-resistant outer structure which is assembled from multiple segments using connectors.

According to the disclosure herein, this object is achieved in each case by the subject matter disclosed herein.

According to a first aspect of the disclosure herein, a method for pretreatment of a surface of non-installed mechanical connectors, in particular for the production of an outer structure of aircraft or spacecraft, is provided. The method comprises the following steps:

Providing a non-installed mechanical connector of which the surface is made of a metal material.

Mechanically and/or physically removing the surface of the mechanical connector, so that an adhesion-promoting layer is produced on the surface.

Securing the mechanical connector to a structure after the surface of the mechanical connector has been mechanically and/or physically removed.

According to a second aspect of the disclosure herein, a system for pretreatment of a surface of non-installed mechanical connectors, in particular for the production of an outer structure of aircraft or spacecraft, is provided. The system comprises a non-installed mechanical connector of which the surface is made of a metal material. The system further comprises a laser system for mechanically and/or physically removing a surface of the mechanical connector and/or a particle jetting system for mechanically and/or physically removing a surface of the mechanical connector, both systems being designed to produce an adhesion-promoting layer on the surface.

According to a third aspect of the disclosure herein, an aircraft or spacecraft comprising an outer structure to which is secured a mechanical connector which has undergone pretreatment using a system according to the second aspect of the disclosure herein is provided.

An idea underlying the disclosure herein includes providing an automatable and combined system for surface treatment of mechanical connectors which are made substantially of a metal material, in order to improve the adhesion of a coating. The metal material comprises or consists of titanium and/or titanium alloys, for example. The processed surface can form a structured surface after the mechanical and/or physical material removal.

It is thus possible to avoid a complex surface treatment, which is often carried out manually, of the mechanical connectors after they are installed. As a result, the production times, in particular the time spent in the paint shop, and the production costs can be reduced.

The pretreatment of the surface can be carried out in automated fashion directly before the mechanical securing elements or connectors are mounted, as a result of which the impact on production is minimal. In the present case, the surface can be locally processed, in particularly mechanically and/or physically removed.

An advantage of the disclosure herein is that, during the paint-finishing of the outer structure, i.e. during the complete paint-finishing of the exterior, the phenomenon of loss of adhesion of the paint to the mechanical connectors can be prevented, since the mechanical connectors are already sufficiently activated or have undergone sufficient pretreatment before they are installed, even the mechanical connectors that penetrate into the outer structure or are recessed therein.

The use of the laser system has the advantage that it affords a more ageing-resistant surface.

Advantageous embodiments and developments will become apparent from the description with reference to the figures.

According to one embodiment of the disclosure herein, the surface is mechanically and/or physically removed by a laser, particle jetting and/or sanding. The particle jetting can comprise for example dry ice blasting, sandblasting or another blasting method in which a blasting medium is accelerated and blasted onto the surface. Surface treatment by a laser or particle jetting allows a considerable improvement in the adhesion of paint, when the paint is applied shortly after the surface treatment.

According to a further embodiment of the disclosure herein, a pulsed infrared solid-state laser is used during laser treatment of the surface. The pulsed infrared solid-state laser can have a laser power in the range of approximately 80 W to approximately 120 W, in particular a laser power of approximately 100 W. Furthermore, the pulsed infrared solid-state laser can have a laser wavelength of approximately 1 pm. The pulsed infrared solid-state laser can further have a pulse duration of approximately 90 ns to approximately 110 ns, in particular a pulse duration of approximately 100 ns.

As an alternative, it is possible to use a laser system for laser treatment of the surface that can provide comparable laser properties to or the same laser properties as the pulsed infrared solid-state laser. The pulsed infrared solid-state laser or the alternative laser system can be stationary with respect to the mechanical connector.

The pulsed infrared solid-state laser or the alternative laser system can further be coupled to or comprise an optics device for reflecting laser beams. The optics device can reflect the laser and focus on the head portion, the entire surface of the head portion being reachable by moving the optics device. The optics device can be moved over the surface in an overlapping pattern. The laser can have a diameter on the surface in the range of approximately 10 μm to approximately 150 μm. The optics device is preferably in the form of a laser scanner. As an alternative or in addition, the pulsed infrared solid-state laser or the alternative laser system can be coupled to or comprise a suction-extraction device.

According to a further embodiment of the disclosure herein, a particle jetting system is used to remove an oxide layer on the surface during particle jetting of the surface. The particle jetting system can use corundum, for example, as the blasting medium. The blasting medium can have a particle size in the range of approximately 25 μm to approximately 550 μm, in particular in the range of approximately 50 μm to approximately 500 μm.

According to a further embodiment of the disclosure herein, the mechanical connector has a head portion, wherein at least the surface of the head portion is mechanically and/or physically removed. The mechanical connector can be in the form of a rivet or a screw, for example. The head portion corresponds for example to that part of the mechanical connector that can be manipulated using a tool. The head portion corresponds by way of example to the screw head of the screw or to the rivet head of the rivet. In some embodiments, it is possible to mechanically and/or physically remove exclusively the surface of the head portion.

According to a further embodiment of the disclosure herein, the method further comprises a step of coating the mechanically and/or physically removed surface of the entire head portion with an organic material. In this way, the entire head portion of the mechanical connector can be coated with the organic material before the head portion, after the mechanical connector has been secured, can only be reached to a limited extent and consequently may not be able to be fully coated in the secured state. In particular, the coating of the head portion can provide protection against oxidation and other weathering influences in those areas of the head portion in which coating is not possible or is possible only to an insufficient extent after the securing. Furthermore, the coating can be carried out just after the mechanical and/or physical material removal, so that no ageing effects on the adhesion-promoting layer occur. The short time between the mechanical and/or physical material removal and the coating can improve a quality of the coating.

The organic material can be a paint, an adhesive, a sealant or the like. The paint can preferably be in the form of a paint for the outer skin of an aircraft or an primer therefor. For example, the surface of the head portion can be coated by a pad-printing device or an encapsulated spray system. The primer or the paint for the outer skin of an aircraft can be provided by a mixer device for mixing small amounts of the paint as and when required. The mixer device can continuously mix paint and feed it to the pad printing device or the encapsulated spray system.

Optionally, the surface can be cleaned and/or an adhesion promoter applied to the surface between the mechanical and/or physical material removal and the coating.

According to a further embodiment of the disclosure herein, the method further comprises a step of curing the organic material by infrared irradiation, hot air, inductive heating or UV irradiation at least with a curing time after which the coating is so dry that contact therewith does not influence it. Therefore, the coating can cure after being applied to an extent that the organic material does not contaminate any other surfaces or adhere to other securing elements. The curing can be assisted by an infrared lamp device or a continuous curing oven. Curing by hot air can be implemented very easily. Curing by inductive heating has the advantage that the coating can be heated up from a boundary layer. Furthermore, inductive heating provides high heating rates and short process times.

Optionally, the method can comprise a step of singulating individual mechanical connectors from a storage container, the mechanical connectors being conveyed from the storage container to a downstream station one after another by a conveyor unit, for example by a pick-and-place robot system and/or by a screw conveyor.

The steps of singulating, mechanically and/or physically removing, coating and curing can be carried out in partly or fully automated fashion. This includes each step per se and optionally a complete or partial sequence of the aforementioned steps.

In particular, the mechanical connector can be secured to the structure, for example an outer structure or outer skin of an aircraft or spacecraft, after the steps of mechanically and/or physically removing, coating and/or curing have been carried out. In some embodiments, the mechanically and/or physically removed surface of the head portion can be coated in the secured state of the mechanical connector or re-coated in the secured state, when the structure is finally coated.

According to a further embodiment of the disclosure herein, the system further comprises a pad-printing device for coating the mechanically and/or physically removed surface of the entire head portion of the mechanical connector with an organic material or an encapsulated spray system for coating the mechanically and/or physically removed surface of the entire head portion of the mechanical connector with an organic material, and an infrared lamp device for curing the organic material by infrared irradiation or a continuous curing oven for curing the organic material by UV irradiation, wherein the laser system and/or the particle jetting system together with the pad-printing device or the encapsulated spray system, and with the infrared lamp device or the continuous curing oven, are in the form of a common working cell. Because the individual processing steps take place close to one another in space and time, a quality of the coating, in particular an adhesion strength of the coating, on the head portion can be improved.

The laser system can be in the form of a pulsed infrared solid-state laser, for example, as described above.

The system can for example form a fully automatic working cell which carries out a surface treatment directly followed by a coating of the head portion. The working cell can have a partition which delimits the systems and devices integrated in the working cell at least partly from a surrounding area. Furthermore, the system can comprise a singulating device for singulating the mechanical connectors from a storage container. Furthermore, the system can comprise a cleaning device for cleaning the surface and/or for applying an adhesion promoter. The singulating device and the cleaning device can be integrated in the working cell.

If appropriate, the above embodiments and developments can be combined with one another in any way desired. In particular, all of the features of the device are transferable to the associated method, and vice versa. Further possible embodiments, developments and implementations of the disclosure herein also comprise combinations of features of the disclosure herein described above or below with regard to the example embodiments that have not been specified explicitly. In particular, a person skilled in the art will also add individual aspects as improvements or additions to the respective basic form of the disclosure herein.

### BRIEF DESCRIPTION OF THE DRAWINGS

The disclosure herein is explained in more detail below on the basis of example embodiments with reference to the accompanying figures of the drawings. In the figures:

FIG. 1 shows a schematic illustration of a system for pretreatment of a surface of non-installed mechanical connectors according to one example embodiment of the disclosure herein;

FIG. 2 shows a schematic side view of an aircraft according to a further example embodiment of the disclosure herein; and

FIG. 3 shows a flow diagram of a method for pretreatment of a surface of non-installed mechanical connectors, in particular for the production of an outer structure of aircraft or spacecraft, according to a further example embodiment of the disclosure herein.

### DETAILED DESCRIPTION

In the figures of the drawing, elements, features and components that are the same, functionally the same and act the same are respectively provided with the same reference signs unless stated otherwise.

Although specific embodiments and developments are shown and described here, a person skilled in the art will prefer that a large number of alternative and/or equivalent embodiments can replace the specific example embodiments shown and described without departing from the scope of the disclosure herein. This application is generally intended to cover all modifications of or changes to the specific example embodiments described herein.

The accompanying figures are intended to convey further understanding of embodiments of the disclosure herein and serve in conjunction with the description for explaining principles and concepts of the disclosure herein. Other example embodiments and many of the stated advantages will become apparent with reference to the drawings. The drawings are to be understood only as being schematic drawings, and the elements of the drawings are not necessarily shown true to scale relative to one another. Direction-indicating terminology such as, for instance, “top”, “bottom”, “left”, “right”, “above”, “below”, “horizontal”, “vertical”, “front”, “rear” and similar indications are used only for explanatory purposes and do not serve to restrict the generality to specific configurations as shown in the figures.

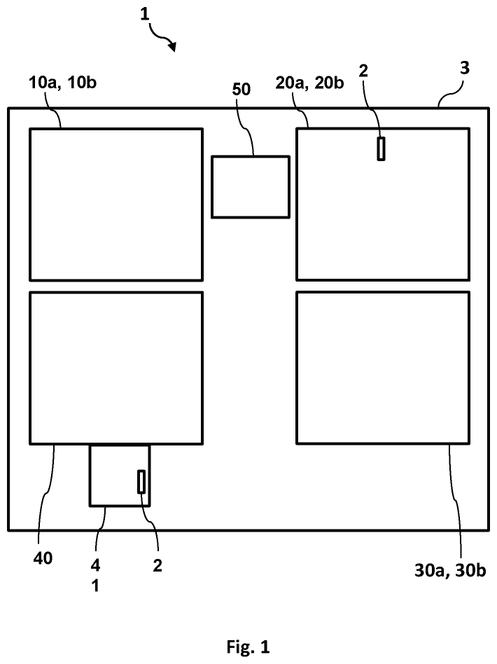

FIG. 1 shows a schematic illustration of a system 1 for pretreatment of a surface of non-installed mechanical connectors 2 according to one example embodiment of the disclosure herein.

The system 1 comprises by way of example a non-installed mechanical connector 2, a laser system 10a or a particle jetting system 10b, a pad-printing device 20a or an encapsulated spray system 20b, an infrared lamp device 30a or a continuous curing oven 30b, a singulating device 40, a storage container 41 and a cleaning device 50.

The laser system 10a or the particle jetting system 10b, the pad-printing system 20a or the encapsulated spray system 20b, the infrared lamp device 30a or the continuous curing oven 30b, the singulating device 40, the storage container 41 and the cleaning device 50 are here integrated in a common working cell 3. The working cell 3 can have a partition which delimits the aforementioned integrated systems and devices at least partly from a surrounding area.

A surface of the mechanical connector 2 is made of a metal material. The metal material comprises or consists of titanium and/or titanium alloys, for example. The mechanical connector 2 can be stored in the storage container 41. The storage container 41 can be filled or replaced by a user from outside the working cell 3. The mechanical connector 2 can be in the form of a rivet or a screw, for example.

The laser system 10a is designed for physically removing and the particle jetting system 10b is designed for mechanically removing the surface of the mechanical connector 2 so that an adhesion-promoting layer is created on the surface.

The laser system 10a can be in the form of a pulsed infrared solid-state laser, for example. The pulsed infrared solid-state laser 10a can have a laser power in the range of approximately 80 W to approximately 120 W, in particular a laser power of approximately 100 W. Furthermore, the pulsed infrared solid-state laser 10a can have a laser wavelength of approximately 1 pm. The pulsed infrared solid-state laser 10a can further have a pulse duration of approximately 90 ns to approximately 110 ns, in particular a pulse duration of approximately 100 ns.

The pulsed infrared solid-state laser 10a can further be coupled to or comprise an optics device for reflecting laser beams. The optics device can reflect the laser and focus on the head portion, the entire surface of the head portion being reachable by moving the optics device. The optics device can be moved over the surface in an overlapping pattern. The laser can have a diameter on the surface in the range of approximately 10 μm to approximately 150 μm. The optics device is preferably in the form of a laser scanner. As an alternative or in addition, the pulsed infrared solid-state laser 10a can be coupled to or comprise a suction-extraction device.

The particle jetting system 10b can use corundum, for example, as the blasting medium. The blasting medium can have a particle size in the range of approximately 25 μm to approximately 550 μm, in particular in the range of approximately 50 μm to approximately 500 μm. The particle jetting system 10b can be designed in particular for removing an oxide layer on the surface.

The pad-printing device 20a and the encapsulated spray system 20b are both designed for coating the mechanically and/or physically removed surface of the entire head portion of the mechanical connector 2 with an organic material. The head portion corresponds for example to that part of the mechanical connector 2 that can be manipulated using a tool. The head portion corresponds by way of example to the screw head of the screw or to the rivet head of the rivet.

The infrared lamp device 30a is designed for curing the organic material by infrared irradiation. The continuous curing oven 30b is designed for curing the organic material by UV irradiation.

The singulating device 40 is designed for singulating the mechanical connectors 2 from a storage container 41. The cleaning device 50 can be designed for cleaning the surface and/or for applying an adhesion promoter.

The system 1 can for example form a fully automatic working cell 3 which carries out a surface treatment directly followed by a coating of the head portion of the mechanical connector 2. As illustrated in FIG. 1, the systems and devices integrated in the working cell 3 can be arranged very compactly in spatial terms. Because the individual processing steps take place close to one another in space and thus also in time, a quality of the coating on the head portion, in particular an adhesion strength of the coating to the head portion, can be improved.

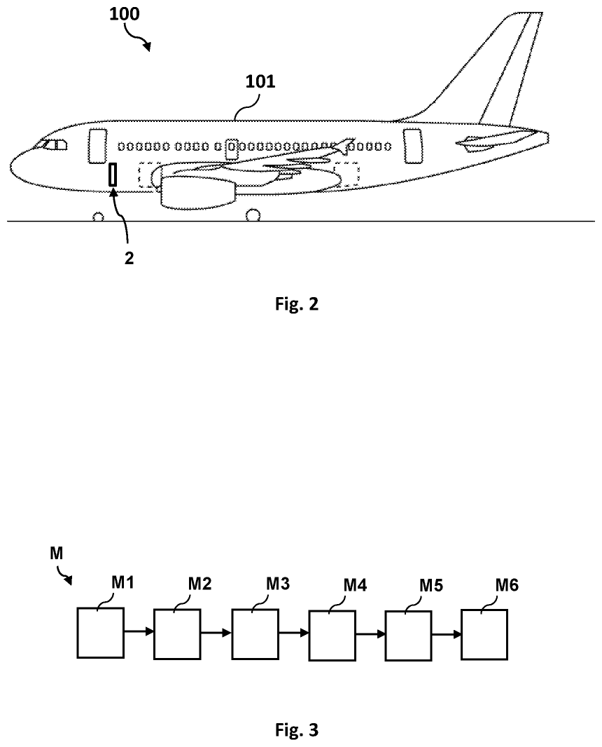

FIG. 2 shows a schematic side view of an aircraft 100 according to a further example embodiment of the disclosure herein.

The aircraft 100 comprises an outer structure 101, or outer skin, which here by way of example is provided on a fuselage, wing surfaces and a tail unit of the aircraft 100. The outer structure 101 contains in particular a plurality of sections which are assembled by at least one mechanical connector 2.

The at least one mechanical connector 2 is secured for example to an outer side of the outer structure 101. The mechanical connector 2 is subjected to a pretreatment using a system 1 from FIG. 1.

FIG. 3 shows a flow diagram of a method M for pretreatment of a surface of non-installed mechanical connectors 2, in particular for the production of an outer structure 101 of aircraft or spacecraft 100, according to a further example embodiment of the disclosure herein.

The method M comprises by way of example the following steps: providing M1 a non-installed mechanical connector 2, singulating M2, mechanically and/or physically removing M3 the surface of the mechanical connector 2, coating M4, curing M5 and securing M6 the mechanical connector 2.

In step M1, the non-installed mechanical connector 2 of which the surface is made of a metal material is provided.

In optional step M2, the mechanical connector 2 can be singulated from a storage container 41, the mechanical connectors 2 being conveyed from the storage container 41 to a downstream station, for example a laser system 10a or a particle jetting system 10b, one after another by a conveyor unit 40 or singulating device. The singulating device 40 can be in the form of a pick-and-place robot system and/or a screw conveyor, for example.

In step M3, the surface of the mechanical connector 2 is mechanically and/or physically removed, so that an adhesion-promoting layer is produced on the surface. For example, the surface can be physically removed M3 by a laser.

A pulsed infrared solid-state laser 10a can be used during laser treatment of the surface in the course of the mechanical and/or physical removing M3. The pulsed infrared solid-state laser 10a can have a laser power in the range of approximately 80 W to approximately 120 W, in particular a laser power of approximately 100 W. Furthermore, the pulsed infrared solid-state laser 10a can have a laser wavelength of approximately 1 pm. The pulsed infrared solid-state laser 10a can further have a pulse duration of approximately 90 ns to approximately 110 ns, in particular a pulse duration of approximately 100 ns. As an alternative, it is possible to use a laser system 10a for laser treatment of the surface that can provide comparable laser properties to or the same laser properties as the pulsed infrared solid-state laser 10a.

The pulsed infrared solid-state laser 10a or the alternative laser system can further be coupled to or comprise an optics device for reflecting laser beams. The optics device can reflect the laser and focus on the head portion, the entire surface of the head portion being reachable by moving the optics device. The optics device can be moved over the surface in an overlapping pattern. The laser can have a diameter on the surface in the range of approximately 10 μm to approximately 150 μm. The optics device is preferably in the form of a laser scanner. As an alternative or in addition, the pulsed infrared solid-state laser 10a or the alternative laser system can be coupled to or comprise a suction-extraction device.

As an alternative or in addition to the laser treatment, the surface can be mechanically removed M3 by particle jetting. A particle jetting system 10b can be used to remove an oxide layer on the surface during particle jetting of the surface. The particle jetting system 10b can use corundum, for example, as the blasting medium. The blasting medium can have a particle size in the range of approximately 25 μm to approximately 550 μm, in particular in the range of approximately 50 μm to approximately 500 μm. The particle jetting can comprise for example dry ice blasting, sandblasting or another blasting method in which a blasting medium is accelerated and blasted onto the surface.

By way of example, the mechanical connector 2 has a head portion, wherein in particular the surface of the head portion is mechanically and/or physically removed M3. The mechanical connector 2 can be in the form of a rivet or a screw, for example. The head portion corresponds by way of example to the screw head of the screw or to the rivet head of the rivet.

Optionally, the surface can be cleaned and/or an adhesion promoter applied to the surface between the mechanical and/or physical removing M3 and the coating M4.

In optional step M4, the mechanically and/or physically removed surface of the entire head portion can be coated with an organic material. In this way, the entire head portion of the mechanical connector 2 can be coated M4 with the organic material before the head portion, after the mechanical connector 2 has been secured M6, can only be reached to a limited extent and consequently may not be able to be fully coated in the secured state. In particular, the coating M4 of the head portion can provide protection against oxidation and other weathering influences in those areas of the head portion in which coating is not possible or is possible only to an insufficient extent after the securing M6. Furthermore, the coating M4 can be carried out just after the mechanical and/or physical removing M3, so that no ageing effects on the adhesion-promoting layer occur. The short time between the mechanical and/or physical removing M3 and the coating M4 can improve a quality of the coating.

The organic material can be a paint, an adhesive, a sealant or the like. The paint can preferably be in the form of a paint for the outer skin of an aircraft or an primer therefor. For example, the surface of the head portion can be coated M4 by a pad-printing device 20a or an encapsulated spray system 20b. The primer or the paint for the outer skin 101 of an aircraft 100 can be provided by a mixer device for mixing small amounts of the paint as and when required.

After the coating M4, in optional step M5 the organic material can be cured by infrared irradiation, hot air, inductive heating or UV irradiation at least with a curing time after which the coating is so dry that contact therewith does not influence it. The curing M5 can be assisted by an infrared lamp device 30a or a continuous curing oven 30b.

The steps of singulating M2, mechanically and/or physically removing M3, coating M4 and curing M5 can be carried out in partly or fully automated fashion. This includes each step per se and optionally a complete or partial sequence of the aforementioned steps M2, M3, M4 and M5.

In step M6, the mechanical connector 2 is secured to a structure after the surface has been mechanically and/or physically removed M3 and possibly also coated M4. In particular, the mechanical connector 2 can be secured M6 to the structure, for example an outer structure 101 or outer skin of an aircraft 100 or spacecraft, after the steps of mechanically and/or physically removing M3, coating M4 and/or curing M5 have been carried out. In some embodiments, the mechanically and/or physically removed surface of the head portion can be coated M4 in the secured state of the mechanical connector 2 or re-coated in the secured state, when the structure, in particular the outer structure 101 of the aircraft 100, is finally coated.

The above-described method steps can be carried out preferably in the order stated, i.e. the order in which they are numbered, but are not limited to this order.

In order to improve the stringency of the representation, in the detailed description above various features have been combined in one or more examples. However, it should be clear in this case that the description above is only of an illustrative and in no way restrictive nature. It is used to cover all alternatives, modifications and equivalents of the various features and example embodiments. Many other examples will be immediately and directly clear to a person skilled in the art on the basis of their technical knowledge in view of the description above.

The example embodiments were chosen and described in order to be able to represent the principles on which the invention is based and their possible uses in practice in the best possible manner. As a result, experts can optimally modify and use the invention and its various example embodiments for the intended purpose. In the claims and the description, the terms “containing” and “having” are used as neutral concepts for the corresponding term “comprising”. Furthermore, use of the terms “a”, “an” and “one” is not intended to fundamentally exclude a plurality of features and components described in such a way.

### List of Reference Signs

1 System
2 Mechanical connector
3 Working cell
10a Laser system
10b Particle jetting system
20a Pad-printing device
20b Encapsulated spray system
30a Infrared lamp device
30b Continuous curing oven
40 Singulating device
50 Cleaning device
100 Aircraft
101 Outer structure
M Method
M1 Providing a non-installed mechanical connector
M2 Singulating
M3 Mechanical and/or physical material removing
M4 Coating
M5 Curing
M6 Securing the mechanical connector

1. A method for pretreatment of a surface of non-installed mechanical connectors for production of an outer structure of aircraft or spacecraft, comprising:
providing a non-installed mechanical connector that comprises a surface made of a metal material;
mechanically and/or physically removing the surface of the mechanical connector so that an adhesion-promoting layer is produced on the surface; and
securing the mechanical connector to a structure after the surface of the mechanical connector has been mechanically and/or physically removed.

2. The method according to claim 1, wherein the surface is mechanically and/or physically removed by a laser, particle jetting and/or sanding.

3. The method according to claim 2, wherein a pulsed infrared solid-state laser is used during laser treatment of the surface.

4. The method according to claim 2, comprising using a particle jetting system to remove an oxide layer on the surface during particle jetting of the surface.

5. The method according to claim 1, wherein the mechanical connector has a head portion, wherein at least a surface of the head portion is mechanically and/or physically removed.

6. The method according to claim 5, further comprising coating the mechanically and/or physically removed surface of an entire head portion with an organic material.

7. The method according to claim 6, further comprising curing the organic material by infrared irradiation, hot air, inductive heating or UV irradiation at least with a curing time after which the coating is so dry that contact therewith does not influence it.

8. A system for pretreatment of a surface of non-installed mechanical connectors for production of an outer structure of aircraft or spacecraft, comprising:
a non-installed mechanical connector that comprises a surface made of a metal material; and
a laser system for mechanically and/or physically removing a surface of the mechanical connector and/or a particle jetting system for mechanically and/or physically removing a surface of the mechanical connector, both systems configured to produce an adhesion-promoting layer on the surface.

9. The system according to claim 8, further comprising:
a pad-printing device for coating the mechanically and/or physically removed surface of an entire head portion of the mechanical connector with an organic material or an encapsulated spray system for coating the mechanically and/or physically removed surface of an entire head portion of the mechanical connector with an organic material; and
an infrared lamp device for curing the organic material by infrared irradiation or a continuous curing oven for curing the organic material by UV irradiation;
wherein the laser system and/or the particle jetting system together with the pad-printing device or the encapsulated spray system, and with the infrared lamp device or the continuous curing oven, are in a form of a common working cell.

10. An aircraft or spacecraft comprising an outer structure to which is secured a mechanical connector which has undergone pretreatment using the system according to claim 8.
